(19) United States
(12) Patent Application Publication
(10) Pub. No.: US 2006/0167744 A1
(43) Pub. Date: Jul. 27, 2006

(54) Sales promotion point exchange method and system

(76) Inventor: Sung-Sam Yoo, TOKYO (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/524,791

(22) PCT Filed: Feb. 6, 2003
(86) PCT No.: PCT/JP03/01206

§ 371 Date: Feb. 16, 2005

(30) Foreign Application Priority Data
Aug. 23, 2002 (JP) 2002-24407

(51) Int. Cl. G06Q 30/00

(52) U.S. Cl. 705/14

(57) ABSTRACT

The sales promotion point exchange transaction method and system of this invention comprises the sales promotion point issuance and consumption server system 200 that issues and consumes sales promotion points per each shop, manufacturer or group of them and consumes sales promotion points within said each shop, manufacturer or group of them based on pre-determined point issuance conditions and pre-determined point consumption conditions and the sales promotion point exchange transaction center 211 that makes said sales promotion points circulate not only within said each shop, manufacturer or group of them but also widely outside said each shop, manufacturer or group of them. Said sales promotion point exchange transaction center 211 manages a standard value of a sales promotion point that is arbitrarily determined by said each shop, manufacturer or group of them and that is consumed within said each shop, manufacturer or group of them, manages an exchange rate between sales promotion points that are issued by and consumed within an each shop, manufacturer or group of them and sales promotion points that are consumed outside said each shop, manufacturer or group of them wherein said exchange rate is arbitrarily determined by said each shop, manufacturer or a group, and executes sales promotion exchange transaction by calculating the necessary point amount required for exchange to a commodity or a service that a user wants based on said standard value of a sales promotion point and on said exchange rate, in response to the user's request.

### TECHNOLOGY AREA

This invention is related to managing and operating technologies for circulation services of sales promotion points such as discount coupons, vouchers or stamps, especially related to managing and operating technologies for more convenient and improved circulation services of sales promotion points using a communication network.

### BACKGROUND OF THE INVENTION

It is a well-known sales promotion method by a manufacturer or by a shopping area to distribute discount coupons, vouchers or stamps at the purchase of commodities by a user. The user can buy commodities at discounted prices at the next purchase by using such discount coupons or vouchers. Terms of “sales promotion points” or simply “points” will be also used to denote such discount coupons, vouchers or stamps in the following part of this document.

Buying intention of users can be further accelerated by specifying the valid period for such coupons or vouchers or by limiting applicable commodities, which results in enhanced sales promotion results.

Recent rapid introduction of computer networks, or the Internet, throughout the world has enabled services such as on-line shopping in a virtual mall on the Internet. There is also an already-known system where a server computer issues points which are equivalent to the discount coupons mentioned above when a user orders a commodity using a Web purchase form, and the server stores and manages such data for each user in a database. In this system, the user can buy commodities at a discounted price according to the amount of accumulated points, by notifying the system his or her ID number.

Such conventional technologies as mentioned above have, however, a problem that the extent where sales promotion points can be used is generally limited within a certain area. That is, the points can be used only for purchasing commodities or applying for a prize offer by a shop or a manufacturer that issues the points. This point usage restriction makes the sales promotion effect very limited.

In order to solve this problem, the applicant has proposed electronic chips for sales promotion that circulate on a communication network (International Publication WO99/60501).

The applicant also proposed a system that is extended from the above invention. The system is to purchase points that can be used only within a limited consumption area and to change them to electronic points that can be used in a wider consumption area (Unexamined Patent Publication 2001-229273).

Although the above mentioned system is totally new in that sales promotion points can be consumed freely without sticking to a specific shop or a manufacturer, the point exchange rate for consumption is fixed to a pre-determined value in the system. In order to operate the system more flexibly to match the sales strategy of each shop or manufacturer, however, it is desired to determine this exchange rate flexibly according to the strategy of each shop or commodity manufacturer.

The purpose of this invention is to solve the above explained problem of previous technologies, and to provide a more convenient electronic point circulation function that can realize stronger and more flexible sales promotion effects.

### DISCLOSURE OF THE INVENTION

This invention is based on an electronic circulating method or system for circulating electronic circulation units. The sales promotion point exchange transaction method and system of this invention include (a) a sales point issuing and consuming means that issues and consumes sales promotion points in response to terminal operation by a user according to issuance and consumption conditions that are pre-determined by a shop, a manufacturer, a shop group, a manufacturer group or a combined group of them (sales promotion point issuance and consumption system 200 in FIG. 2), and (b) a sales promotion point exchange transacting means that makes said the sales promotion points work as more widely circulating points (sales promotion point exchange transaction center 211). Said sales promotion point exchange transacting means manages standard prices that are set freely by said shop, manufacturer or group of them who issues said sales promotion points, manages the exchange rate between the sales promotion points consumed at said shop, manufacturer or group of them and the sales promotion points consumed at outside said shop, manufacturer or group of them, calculates per request by said user the necessary point value required to change to a commodity or service that the user wants to purchase, according to said standard prices and said exchange rate, and carries out exchange transaction of sales promotion points according to the calculation results.

At the first operation stage of the sales promotion point exchange transaction method and system of this invention, sales promotion points (or simply referred as “points” in this document) that are electronic circulation units and that are issued by and circulated within each of pre-determined shop, manufacturer, or group of them, are issued and consumed at the terminal operation by a user for purchase or usage of commodities or services, based on pre-determined point issuance conditions and point consumption conditions. This terminal operation is the point issuance or consumption operation by a user limited only for purchase of commodities or usage of services at a prescribed shop or manufacturer or group of them. Said terminal operation by a user can be an access operation on a personal computer (referred simply as a “PC” hereafter) in the user's home and connected to the Internet to a home page where commodities or services can be ordered. Also, said points include sales promotion points that can be acquired by accessing to an advertising home page or a banner on the Internet. By enabling these operations, both chances for a user to see advertisement and user's motivation to utilize points can be increased, since points can be acquired not only through paid commodity purchase or service usage but also through free access to an advertisement home page or a banner. A user can accumulate points by repeating operations mentioned above. The operation can be realized by the electronic circulating method and system for electronic circulating units that are proposed by the applicant in International Publication WO99/60501.

At the next operation stage of this invention, the user operates the terminal in order to request the sales promotion point exchange transaction system of this invention an estimation whether the user can purchase (exchange to points) a desired commodity or a service among those provided by enterprise members of the system by using already accumulated sales promotion points that are issued by and circulated within each of pre-determined shop, manufacturer, or group of them.

On the other hand, a shop, a manufacturer or a group of them that issues points determines a standard value of a point that is consumed within its own shop, manufacturer or group of them, sets an exchange rate between a point that is consumed within its own shop, manufacturer or group of them and a point that is consumed outside its own shop, manufacturer or group of them according to sales strategy of each shop, manufacturer or group of them, and registers said standard value and said exchange rate on the sales promotion point exchange server of the sales promotion point exchange transaction system.

Since said exchange rate can be set freely by each shop, manufacturer or group of them that provides commodities or services according to each sales strategy or according to each commodity or service, through this system it is possible to guide users to repeat purchasing commodities or services they provide, which is the original intention of sales promotion points.

Also, the exchange rate can be set according to the season, the date or the period, and according to the attribute of each user, which enable more sophisticated user guidance to desired sales.

Moreover, the exchange rate can be altered at anytime, and this change can be reflected on actual point issuance or consumption by real time communication through the network.

Additionally, it becomes possible for this system to open a gaming home page or a quiz home page and to use said points as the prize for the game or the quiz to feed back to the user who participated in the game or the quiz. By setting a point value as the participation fee to the game or the quiz small enough, the user can expect that the point amount increase through the game or the quiz, so that utilization of points will be accelerated. Especially, usage of the user's dead stock of unused but valid points can be promoted effectively, enhancing the usefulness of the points.

At the third operation stage of this invention, the sales promotion point exchange transaction center calculates and returns the estimation results, such as the current price of the requested commodity and the user's current accumulated point value, to the user terminal that displays the results, by referring to the sales promotion point exchange server system in said sales promotion point exchange transaction system for data such as the point standard value of the requested commodity, the point exchange rate and the user's present accumulated point value per designated shop, manufacturer or group of them.

The user decides whether or not to exchange the required points for the commodity, and inform the sales promotion point exchange transaction center the usage of points if the user decided to exchange. At receiving the notice form the user, the sales promotion point exchange center issues exchange order to the enterprise that provides the requested commodity or service and executes payment. by points, and then notifies the transaction result to the user. At the same time, the sales promotion point exchange center renews the user's present accumulated point value data per designated shop, manufacturer or group of them according to the result of the exchange transaction, stores the data in the sales promotion point exchange server system of the sales promotion point exchange transaction center, and notifies the result to the user.

### DESCRIPTION OF DRAWINGS

FIG. 1 shows the operation flow in the sales promotion point exchange transaction system of this invention.

FIG. 2 shows the embodiment configuration of the sales promotion point exchange transaction system of this invention.

FIG. 3 shows a display image example displayed on a user terminal when a user registers his or her name to the system as a user member of the system.

FIG. 4 shows a display image example displayed on an enterprise terminal when an enterprise registers itself to the system as an enterprise member of the system.

FIG. 5 shows a display image example displayed on an enterprise terminal when an enterprise resisters its point exchange rate table to the system.

FIG. 6 shows another display image example displayed on an enterprise terminal when an enterprise resisters its point exchange rate table to the system.

FIG. 7-a shows a display image example of the point estimation response to the user displayed on a user terminal.

FIG. 7-b shows another display image example of the point estimation response to the user displayed on a user terminal.

FIG. 8 shows a data table example that is stored in the sales promotion points exchange transaction system as the point exchange transaction data.

FIG. 9 shows the operation flow when a user member receives a gaming service.

### DESCRIPTION OF THE PREFERRED EMBODIMENT

The preferred embodiment of the sales promotion point exchange transaction system and method of this invention will be explained hereinafter referring to drawings.

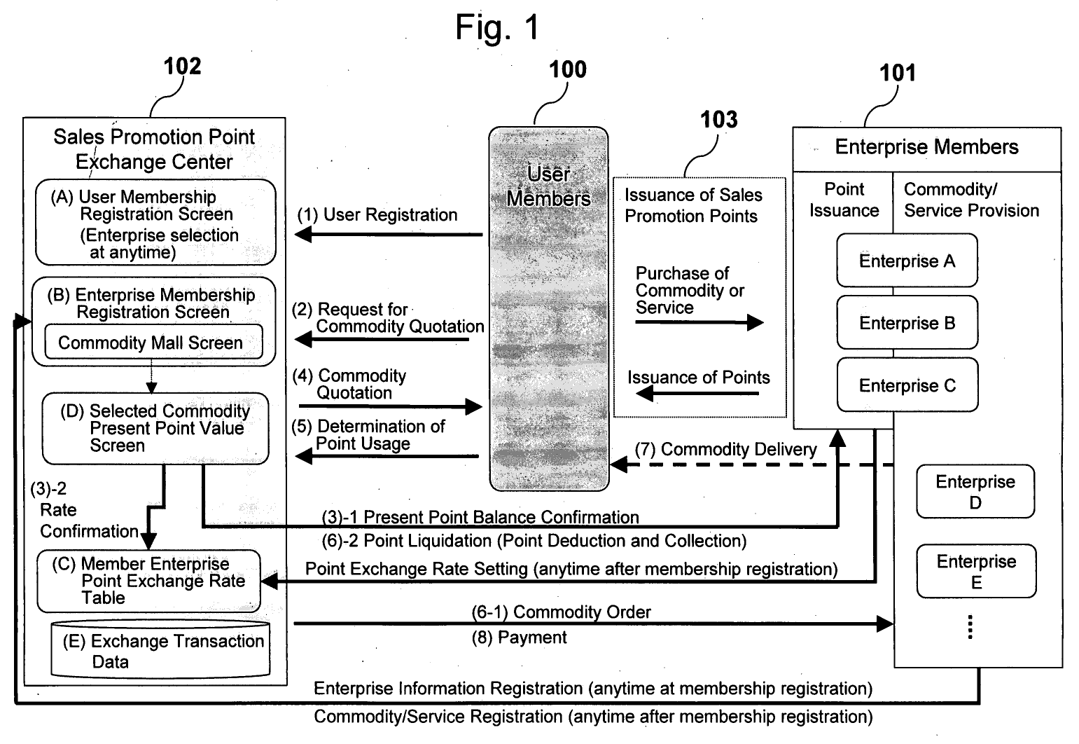

FIG. 1 shows the operation flow in the sales promotion point exchange transaction system of this invention. The sales promotion point exchange transaction system of this invention is operated by user members (or users) 100 in FIG. 1 who purchase commodities or services and who are the users of the sales promotion point exchange transaction system, enterprise members 101 of the sales promotion point exchange transaction service realized by the sales promotion point exchange transaction system of this invention, and the sales promotion point exchange transaction center 102 that operates the sales promotion point exchange transaction system of this invention. Here an enterprise member means a provider of commodities or services such as a shop, a manufacturer of commodities or a game service provider, including a commodity or service provider on the Internet Web.

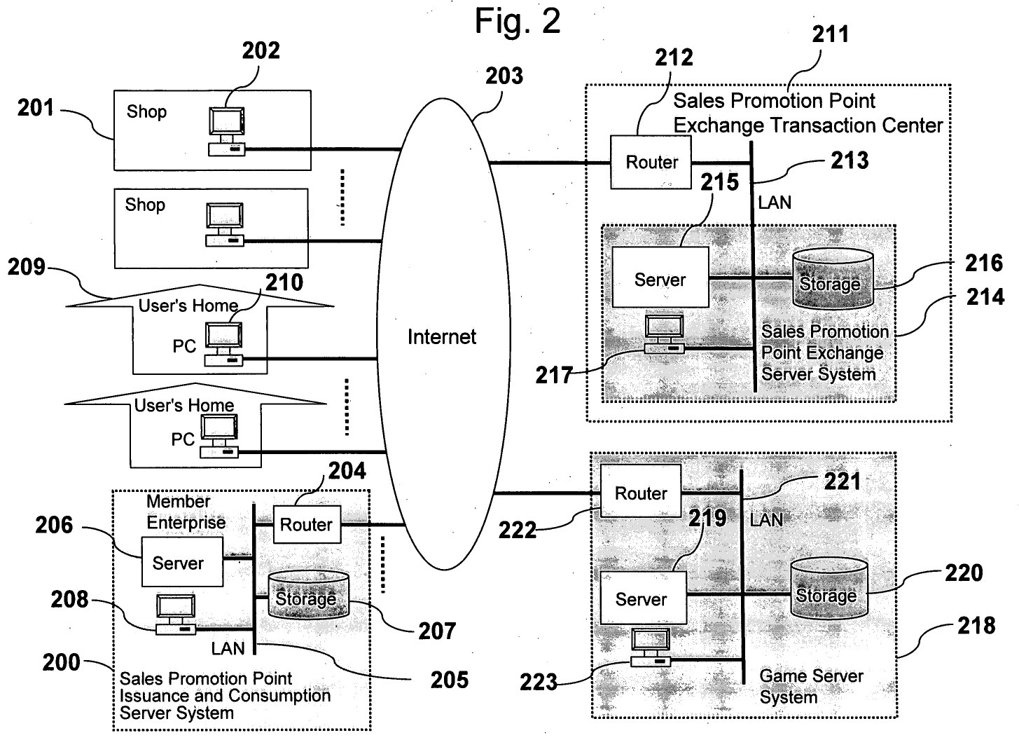

FIG. 2 shows the embodiment configuration of the sales promotion point exchange transaction system of this invention.

For simplicity of explanation, it is assumed that a user who wishes to become a user member of the sales promotion point exchange transaction system of this invention has already participated in a sales promotion point issuance and consumption service that is provided by a commodity or service provider who owns (or who participates in) a sales promotion point issuance and consumption system where the sales promotion points can circulate only in a pre-determined shop, manufacturer or group of them. A sales promotion point issuance and consumption system where the sales promotion points can circulate only in a pre-determined shop, manufacturer or group of them as mentioned above can be realized by another invention of the applicant referred previously (International Publication WO99/60501). A sales promotion point issuance and consumption server system 200 is shown in FIG. 2, as an embodiment example of the sales promotion point issuance and consumption system referred above. The sales promotion point issuance and consumption server system 200 in FIG. 2 may comprise a server 206, a storage device 207, an information input/output terminal 208, a router 204 and a LAN 205 as shown in FIG. 2, but the system configuration is not necessarily limited to this; all or some of the storage device, the router and the LAN may be included in the server as a part, or the server may be an ordinary PC. Since detailed explanation of functional principle and features of the sales promotion point issuance and consumption server system 200 is shown in the above-mentioned reference, it will not be repeated here.

As shown in procedure 103 in FIG. 1, when a user (one of user members 100 in FIG. 1) of the sales promotion point exchange transaction system purchases a commodity or a service provided by an enterprise member 100 of the system at a shop of the enterprise member or at a shop of another enterprise member, sales promotion points that are circulating units corresponding to some prescribed percentage of the purchased value are issued to the user.

This procedure is broken down as the following by using the embodiment configuration of FIG. 2 for an example of purchasing a commodity or a service at a real shop 201 (the procedure is the same for a case where purchasing is carried out by using the Web screen on a PC in a user's home).

A user or a shop employee enters the user's ID (a new ID is issued for a new user) at the sales promotion point client terminal 202 in the shop 201. Then purchased value is entered manually by the shop employee or automatically after the user's terminal operation in case of Web purchasing. These entered data are transmitted through the Internet 203, the router 204 in the sales promotion point issuance and consumption server system 200 of a pre-determined enterprise (a shop, a manufacturer or a group of them) and the local area network (LAN) 205 and stored in the server 206 of the sales promotion point issuance and consumption server system 200. The server 206 issues sales promotion points that are circulating units corresponding to some prescribed percentage of the purchased value to the user, according to pre-determined issuance conditions. The issued point value is stored in the storage device 207 in the service promotion point issuance and consumption server system 200. The user can receive a discount in purchasing a commodity or a service, by using points that the user has accumulated. In such a case, the server 206 calculates the purchasing price after using the points according to pre-determined point consumption conditions and the remaining points after the purchase. The calculated results are displayed on the sales promotion point client terminal 202 in the shop 201, and the stored contents of the server 206 in the sales promotion point issuance and consumption server system 200 are renewed by these calculated results. The issuance history and the consumption history, together with the issuance conditions and the consumption conditions, are managed by the server 206 and stored in the storage device 207, both of which are in the sales promotion point issuance and consumption server system 200.

The above described procedure is applied only to the sales promotion electronic point issuance and consumption service that is provided within a pre-determined shop, manufacturer or group of them, and this service is realized by mutual data communication through the Internet 203 between the sales promotion point client terminal 202 in the shop 201 or the PC 210 in the user home 209 and the sales promotion point issuance and consumption server system 200 of the enterprise, as shown in FIG. 2.

In the sales promotion point exchange transaction system of this invention, the sales promotion point exchange transaction center 211 in FIG. 2 is newly added and connected to the above described system through the Internet 203. By this whole system configuration, the sales promotion point exchange transaction service that is the objective of this invention can be realized through mutual data communication via the Internet 203 between the sales promotion point client terminal 202 in the shop 201 or the PC 210 in the user home 209, the sales promotion point issuance and consumption server system 200 of the enterprise and the sales promotion point exchange transaction center 211.

Although the sales promotion point exchange transaction center 211 in FIG. 2 is composed of the sales promotion point exchange system 214, a router 212 and a LAN 213, where the sales promotion point exchange system 214 is composed of a server 215, a storage 216 and an information input/output terminal 217, the configuration of the sales promotion point exchange transaction center of this invention is not limited to this composition. For example, all or some of the storage device, the router and the LAN may be integrated into the server itself, or the server may be a general purpose PC.

In the operation flow in FIG. 1, a user (a consumer) who wishes to receive the sales promotion point exchange transaction services must first register membership of this service (procedure (1) in FIG. 1). The user can perform the registration operation on a Web browsing screen of the sales promotion point client terminal 202 in a shop 201 in FIG. 2 or of the sales promotion point client terminal at the user's home (actually the PC 210 connected to the Internet), according to directions displayed on the Web screen. Since the sales promotion point client terminal 201 or the PC 210 is connected to the sales promotion point exchange server system 214 through the Internet 203 and the router 212 and the LAN 213 both of which are in the sales promotion point exchange transaction center 211, the procedure above is carried out through data exchange between the sales promotion point exchange server system 214 and the sales promotion point client terminal 202 or the PC 210. In other words, the input page display on the sales promotion point client terminal 202 or the PC 210 is generated by the server 215 in the sales promotion point exchange server system 214, and transmitted to the sales promotion point client terminal 202 or to the PC 210 via the LAN 213, the router 212 and the Internet 203.

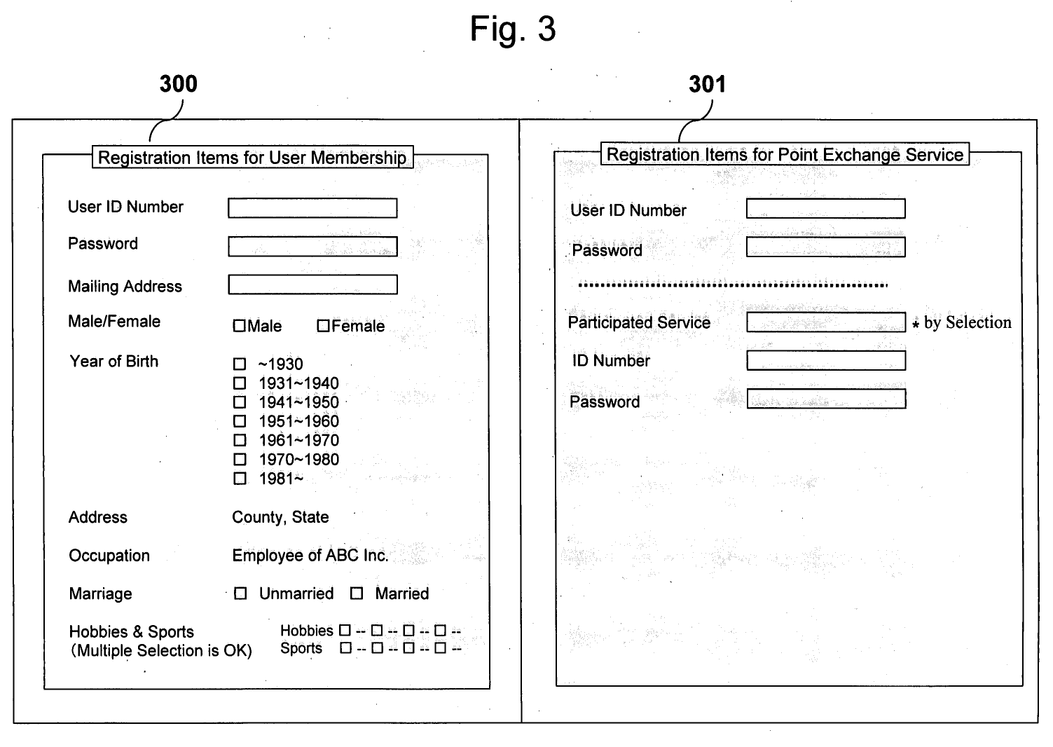

FIG. 3 shows a display image example displayed on the sales promotion point client terminal 202 or on the PC 210 when a user registers his or her name to the system as a user member of the system. The figure is an example of the page shown as “(A) User Membership Registration Screen” in FIG. 1. Items shown as “Registration Items for User Membership” 300 in FIG. 3 are profile data of the user that are necessary for the user to become a user member of the sales promotion point exchange transaction system of this invention. Items shown as “Registration Items for Point Exchange Service” are information the user must register in the system about commodity/service providers of which commodities or services the user wants to purchase.

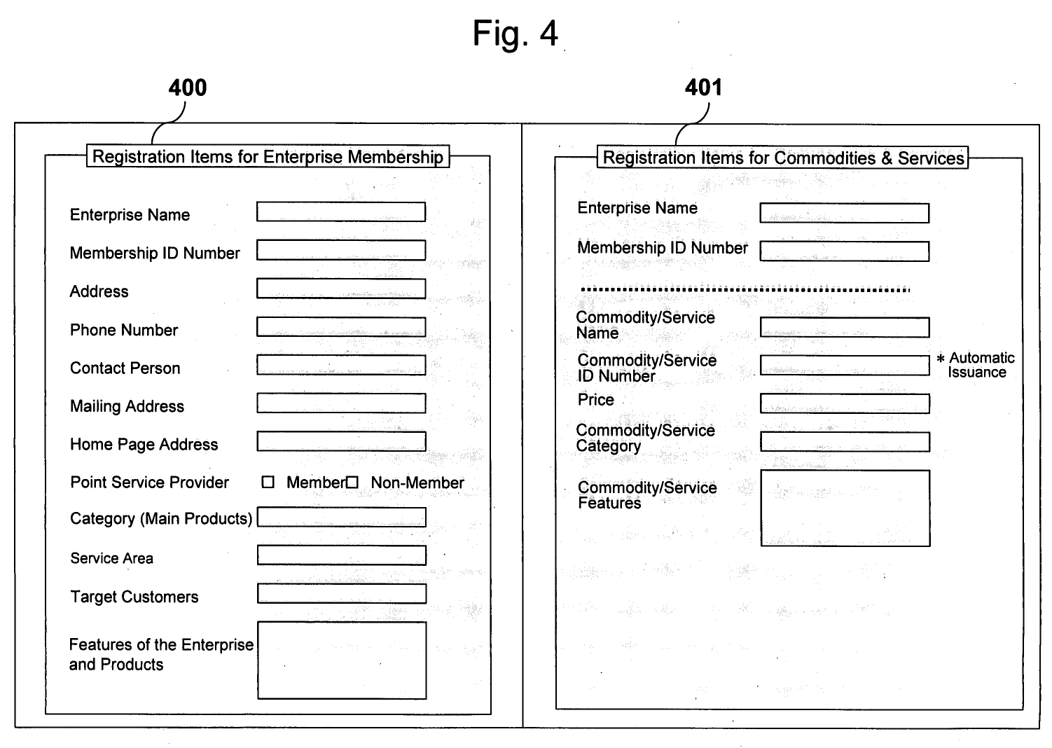

An enterprise (one of enterprise members 101 in FIG. 1) who wishes to participate in the sales promotion point exchange transaction services realized by the sales promotion point exchange transaction system of this invention must first register information on the enterprise in the system (the page shown as “(B) Enterprise Membership Registration screen” in FIG. 1). FIG. 4 shows a display image example for enterprise registration that the system provides. “Registration Items for Enterprise Membership” 400 in FIG. 4 are profile data of an enterprise that are necessary for the enterprise to become an enterprise member of the sales promotion point exchange transaction system of this invention. “Registration Items for Commodities & Services” 401 in FIG. 4 are information the enterprise must register in the system about commodities or services that the enterprise provides.

There are two types of enterprises; one is an enterprise that provides its own commodities or services and issues its own sales promotion points by itself (the Enterprise A, B or C in FIG. 4), and the other is an enterprise that provides its own commodities or services but does not issue its own sales promotion points (the Enterprise D or E in FIG. 4). The registration page in FIG. 4 shows an example that can be applied for both types of enterprises.

The registration page as shown in FIG. 4 is generated by the server 215 of the sales promotion point exchange server system 214 in FIG. 2, and transmitted to each enterprise member through the LAN 213, the router 212 and the Internet 203. If the enterprise member by itself possesses and operates the sales promotion point issuance and consumption server system 200, this registration page information is sent to the server 206 through the router 204 and the LAN 205 in the sales promotion point issuance and consumption server system 200, and displayed on the information input/output terminal 208. The enterprise member enters the required information according to the displayed instruction on the terminal screen.

An enterprise member who issues sales promotion points but does not own nor operates a sales promotion point issuance and consumption server shown as 200 in FIG. 2 and who relies on operation by another enterprise or by a dedicated operator (including the case where the operator of the sales promotion point exchange transaction system of this invention 211 serves also as said dedicated operator), or an enterprise member who does not issue sales promotion points and who only sells commodities or services, receives the registration page information by a dedicated terminal similar to the sales promotion point client terminal (202 in FIG. 2) or by a PC connected to the Internet and is similar to the one in a user's home (210 in FIG. 2), and enters required information according to the instruction displayed on the screen of the terminal or the PC.

If the operator of the sales promotion point exchange transaction system of this invention 211 serves also as said dedicated operator of the sales promotion point issuance and consumption server system 200, the sales promotion point issuance and consumption server 200 can be directly connected to the LAN 213 of the sales promotion point exchange server system 214, instead of being connected to it through the Internet 203 and the router 212 as shown in FIG. 2. Also in this case, the sales promotion point issuance and consumption server system 200 and the sales promotion point exchange server system 214 are not necessarily composed as two physically independent systems. For example, only the sales promotion point exchange server system 214 can exist with one or several integrated modules working for functions of the sales promotion point issuance and consumption server system 200, or inversely, only the sales promotion point issuance and consumption server system 200 can exist with one or several integrated modules working for functions of the sales promotion point exchange server system 214.

After the initial membership registration through the registration page of (B) in FIG. 1, the enterprise member can send at any time a commodity mall page advertising its own commodities or services to every user member through the sales promotion point exchange server system 214 in the sales promotion point exchange transaction center (211 in FIG. 2) of this invention.

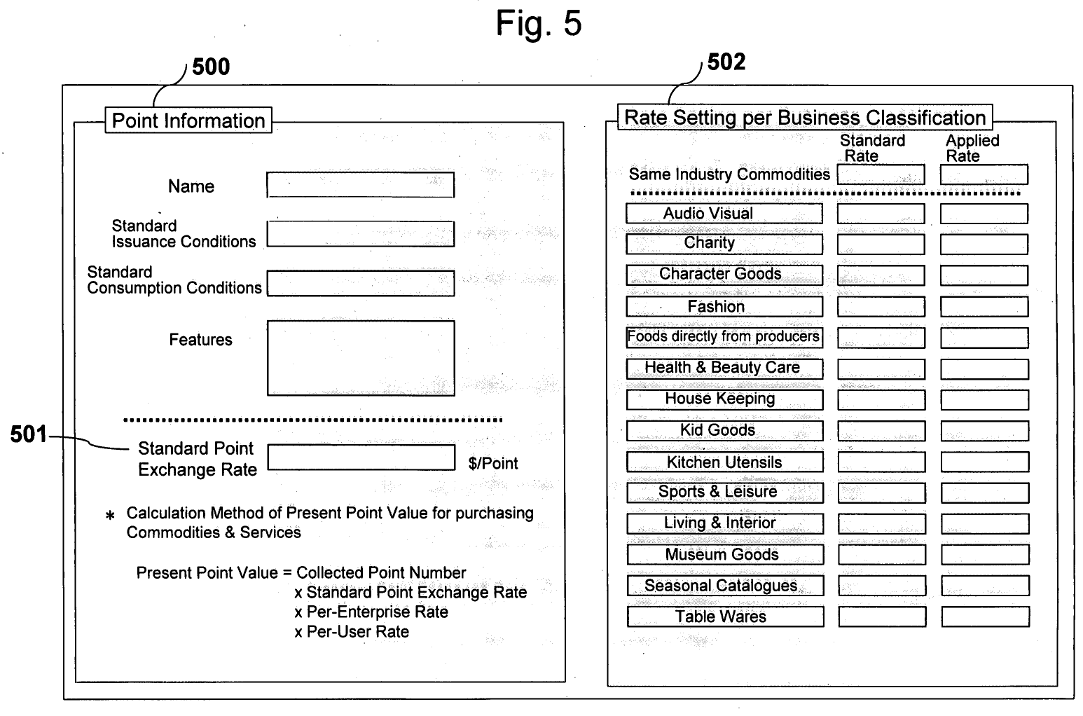

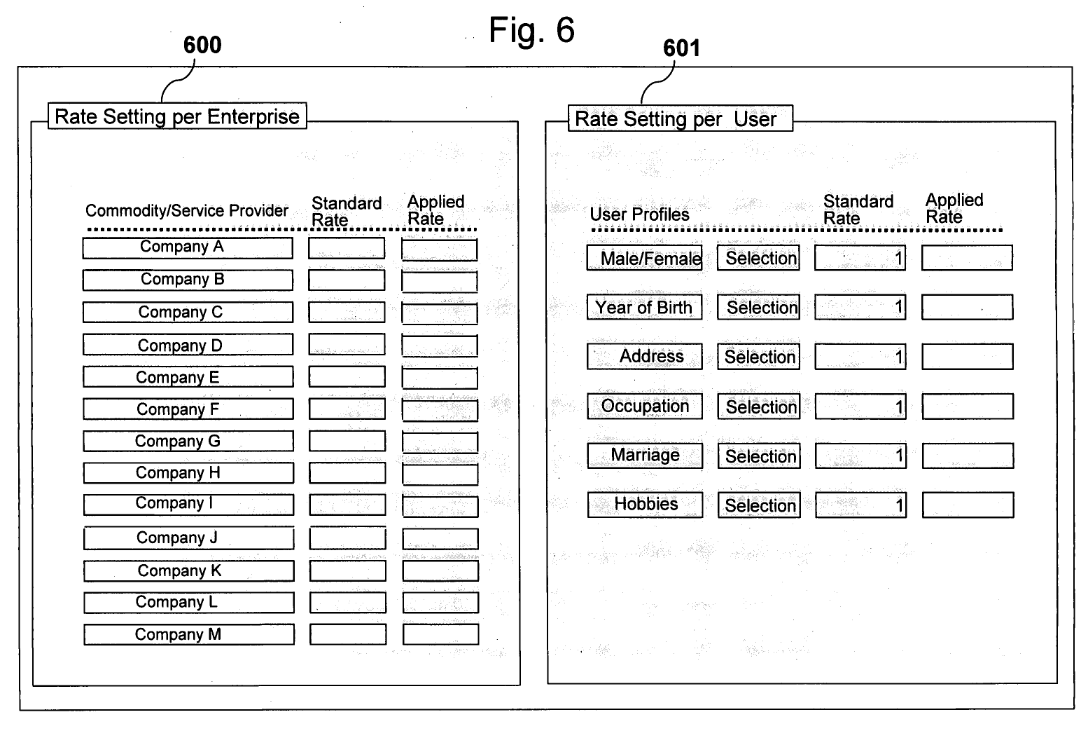

Also after the initial membership registration, the enterprise member can register at any time the necessary information on sales promotion points, in other words a point rate table, into the sales promotion point exchange server system 214 in the sales promotion point exchange transaction center 211 (procedure (C) in FIG. 1). Registration page examples for this procedure are shown in FIGS. 5 and 6.

The registration procedure is similar to the initial membership registration procedure. That is, the registration pages shown in FIGS. 5 and 6 are generated by the server 215 of the sales promotion point exchange server system 214 in FIG. 2, and transmitted to each enterprise member through the LAN 213, the router 212 and the Internet 203. If the enterprise member by itself possesses and operates the sales promotion point issuance and consumption server system 200, this registration page information is sent to the server 206 through the router 204 and the LAN 205 in the sales promotion point issuance and consumption server system 200, and displayed on the information input/output terminal 208. The enterprise member enters the required information according to the displayed instruction on the terminal screen.

An enterprise member who does not own a sales promotion point issuance and consumption server shown as 200 in FIG. 2 can receive the registration pages as are shown in FIGS. 5 and 6 by a dedicated terminal similar to the sales promotion point client terminal (202 in FIG. 2) or by a PC connected to the Internet and is similar to the one in a user's home (210 in FIG. 2), and can enter required information according to the displayed instruction on the screen of the terminal or the PC.

“Point Information” 500 shown in FIG. 5 is the fundamental information items on sales promotion point services that the enterprise member provides, such as the point service name, issuance conditions, consumption conditions, service features and the standard point exchange rate. “Standard Point Exchange Rate” 501 in FIG. 5 is the standard exchange rate between the point and the currency (¥/point) determined by the enterprise. “Rate Setting per Business Classification” 502 in FIG. 5 shows a table where the registering enterprise can set each exchange rate of sales promotion points that the enterprise issues according to each member enterprise for which commodity or service the points are consumed. Thus, the enterprise can set the point exchange rate flexibly based on its sales promotion strategy in such ways as setting the rate at a lower value if the points are consumed for purchasing commodities or services provided by an other enterprise than itself in the same business category of its own, or as setting the rate at a higher value if the points are consumed for purchasing commodities or services provided by an enterprise in a different business category and if some business promotion can be expected by this higher rate setting. Both the standard exchange rate and the actually applied exchange rate under specified conditions can be set for the rate setting per business classification as shown in FIG. 5.

“Rate Setting per Enterprise” 600 in FIG. 6 shows a table where the registering enterprise can set more minutely each exchange rate of sales promotion points that the enterprise issues according to a member enterprise other than itself for which commodity or service the points are consumed. Both the standard exchange rate and the actually applied exchange rate under specified conditions can be set for each rate setting per enterprise as shown in FIG. 6.

“Rate Setting per User” 601 in FIG. 6 shows a table where the registering enterprise can set each exchange rate of sales promotion points according to the profile of each user member. By using this rate setting capability, the enterprise can expand means for its business promotion strategy remarkably, giving a prioritized high exchange rate to customers who purchase commodities or services of the enterprise repeatedly, or targeting selected users for a specific sales campaign.

Sales promotion point data that are entered by each enterprise from time to time are combined at the server 215 in the sales promotion point exchange server system 214 as each “enterprise member point rate table” per enterprise member and stored in the storage device 216. Each of the tables is renewed at every new input.

When a user member consumes the collected points for purchasing a commodity or a service, the sum of each point value amount that is accumulated by the user for each member enterprise becomes the available total point value that the user can actually use for the purchase. Here, the point value amount that is accumulated by the user for a member enterprise is calculated as (the point number accumulated by the user for the enterprise)×(standard point exchange rate of the enterprise)×(per-enterprise rate that the enterprise determined)×(per-user rate that the enterprise determined).

A user member who has already registered membership of the sales promotion point exchange transaction system of this invention through the procedure (1) in FIG. 1 can use the accumulated points for purchasing commodities or services that enterprise members provide, by using the sales promotion point exchange transaction system of this invention. When a user decides through a web mall of a member enterprise to use accumulated points for purchasing a commodity or a service that the enterprise provides, the user requests an estimation of the present available point value for purchasing the commodity or the service to the sales promotion point exchange transaction system of this invention (procedure (2) in FIG. 1). This requesting operation can be carried out on a sales promotion point client terminal 202 in a shop as shown in FIG. 2, or on a PC 210 in the user's home, which is similar to the operation for user membership registration.

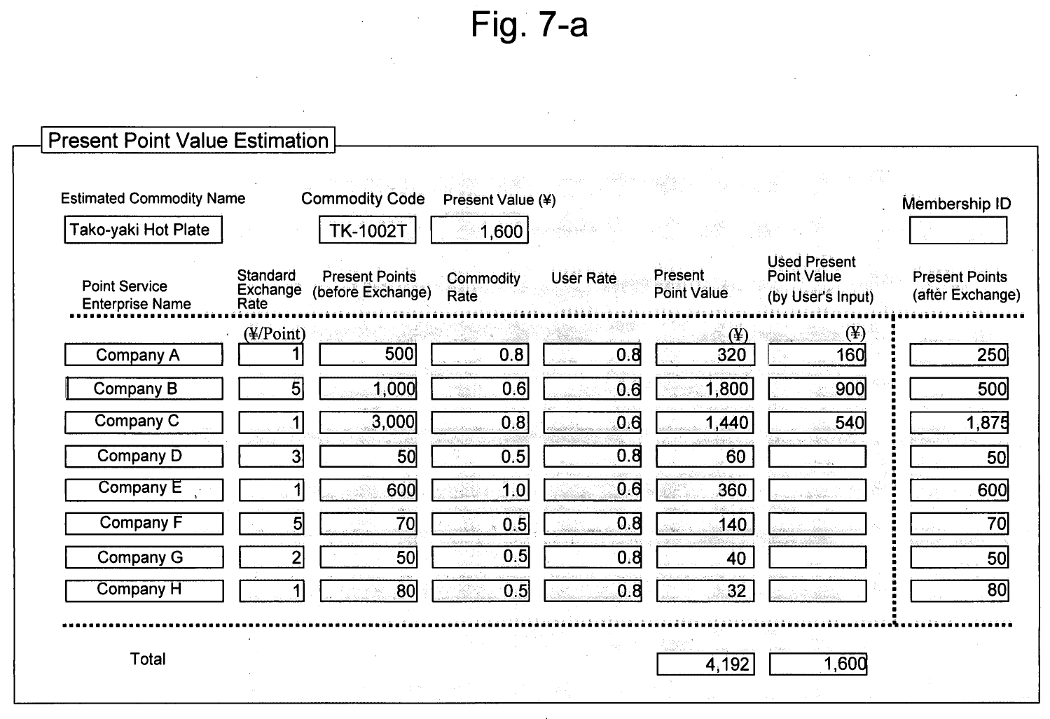

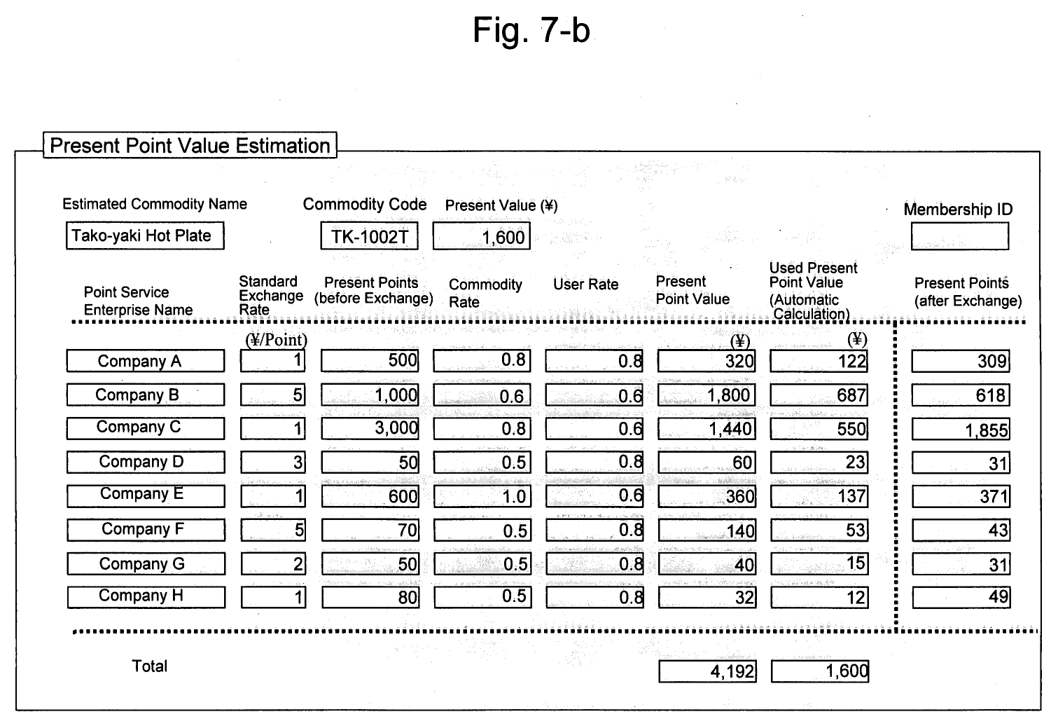

At receiving this request, the server 215 of the sales promotion point exchange transaction system 214 inquires of each enterprise member's sales promotion point issuance and consumption server system (shown as 200 in FIG. 2) about the user's present accumulated point amount and confirms the user's presently usable point number (the point balance) for each member enterprise (procedure (3)-1 in FIG. 1), refers to the enterprise member point exchange rate table in the storage device 216 of the sales promotion point exchange server system in order to confirm each exchange rate of each enterprise member for this user and for this commodity or service (procedure (3)-2 in FIG. 1), calculates the usable point number for the user based on the results of above confirmation and responds back to the user with the calculated estimation result (procedure (4) in FIG. 1). Examples of a response displaying screen of (D) in FIG. 1 are shown in FIG. 7-a and in FIG. 7-b.

The example in FIG. 7-a shows the case for purchasing (exchanging points to the commodity) a “Tako-Yaki” hot plate of which price is 1,600 yen. For simplicity of explanation, it is assumed that the information for this commodity such as the price has already been registered in the sales promotion point exchange server system 214 of this invention by the enterprise member who provides the commodity through the procedure explained heretofore. In this case, the user has already acquired points of seven member enterprises from Company A to Company H. The user's present point balance for each enterprise is shown in the column of “Present Point (before Exchange)” in FIG. 7-a. The standard point exchange rate that each member enterprise determined, the exchange rate for the provider (or provider's business type) that provides the commodity, and the exchange rate for the user are shown in the column of “Standard Exchange Rate”, “Commodity Rate” and “User Rate”, respectively, per each member enterprise (commodity vendor).

Detailed explanation for calculation procedure of the point estimation is shown using an example of points for Corporation C. Since the standard point exchange rate for Corporation C is 1 (yen/point), the present point number before exchange is 3,000, the commodity rate is 0.8 and the user rate is 0.6 for the commodity of Corporate C, respectively, the present point value of the user for points of Corporate C is calculated as 1×3,000×0.8×0.6=1,440 yen. This value is shown in the column of “Present Point Value” in FIG. 7-a. The column of “Used Present Point Value (by User's Input)” is the column for the user to decide and to enter the point value that is used for purchasing the commodity. In this example, the user decided to use 160 yen equivalent point value out of 320 yen equivalent point value of Company A, similarly 900 yen equivalent point value out of 1,800 yen equivalent point value of Company B and 540 yen equivalent point value out of 1,440 yen equivalent point value of Company C, in order to buy the Tako-Yaki hot plate pricing 1,600 yen. Thus the used point number is determined when the column of “Used Present Point Value (by User's Input)” in FIG. 7-a is filled by the user as exemplified above, and the result is notified to the sales promotion point exchange transaction server system 214 in FIG. 2 (procedure (5) in FIG. 1).

The point balance of the user after purchasing this commodity by using a portion of collected points is shown in the column of “Present Points (after Exchange)” in FIG. 7-a. This column is calculated by the server 215 of the sales promotion point exchange server system 214 as (1,440−540)/(1×0.8×0.6)=1,875 points in case of Company C, for example, and the calculation results are shown on the screen of the user's PC. Instead of user's manual data input to the column of “Used Present Point Value (by User's Input)” in FIG. 7-a, automatic data input for this column by using automatic calculation based on proportional distribution of the points to be used to each company, for example, can be possible as shown in FIG. 7-b.

At receiving the notice that the user decided to use the points, the server 215 of the sales promotion point exchange server system 214 issues a purchase order of the commodity (a Tako-Yaki hot plate) to the enterprise member who is the manufacturer of this commodity (procedure (6)-1 in FIG. 1). At the same time, the server 215 subtracts the amount of used points at this point exchange transaction (purchasing the commodity) from the accumulated points before the exchange transaction for each member enterprise, and notice the results to each enterprise member. This procedure is understood as the account settlement and the payment collection for the transaction (procedure (6)-2 in FIG. 1).

At receiving the purchase order, the member enterprise sends the commodity to the user (procedure (7) in FIG. 1. In parallel with this, an operator of the sales promotion point exchange server system 214 pays the price of the commodity to the member enterprise that provided the commodity (procedure (8) in FIG. 1.

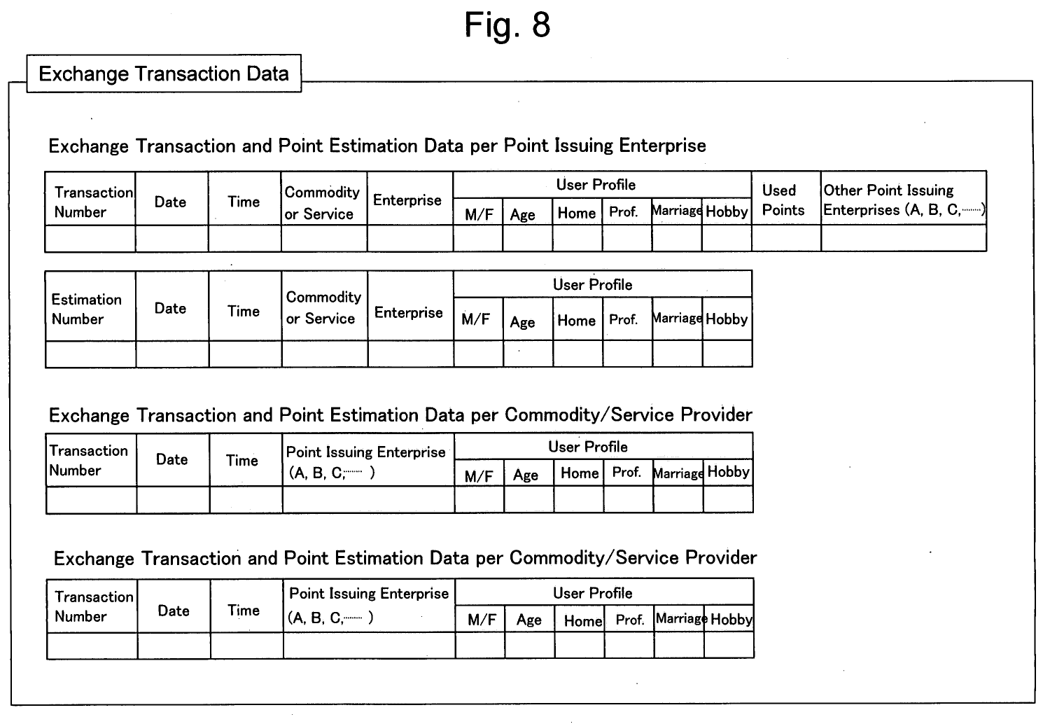

The server 215 in the sales promotion point exchange server system 214 arranges various detailed exchange transaction data at each exchange transaction by each user for various different categories, and stores them in the storage device 216 in the sales promotion point exchange server system 214 as a part of “point exchange transaction data”. Since the point exchange transaction data are accumulated by each point exchange transaction by each user, the data can be effectively utilized by the operator of the sales promotion point exchange transaction server system 214 to maintain and to upgrade the point exchange service, or by each enterprise member of this sales promotion point exchange transaction system to establish its sales strategy. FIG. 8 shows an example of point exchange transaction data to be stored in the system.

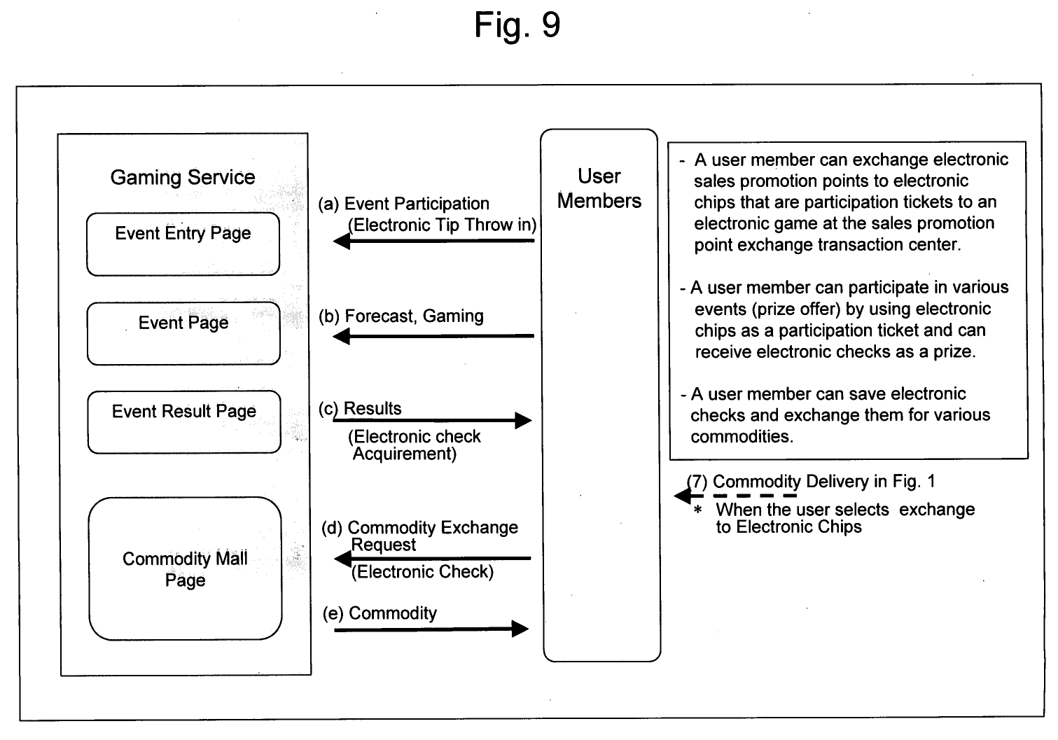

It is possible for a user of the sales promotion point exchange transaction system of this invention to exchange the user's points that are collected through purchasing of commodities or services provided by the member enterprises to electronic tickets that can be used for receiving a service such as an electronic game, a questionnaire or a quiz. FIG. 9 shows a procedure flow of a gaming service as an example for a user member of the sales promotion point exchange transaction system of this invention to receive a gaming service. The game server system 218 in FIG. 2 shows a configuration example for a gaming service system by which a member enterprise of the sales promotion point exchange transaction system of this invention provides electronic games. Although the game server system 218 can be configured by a server 219, a storage device 220, an information input/output terminal 223, a router 222 and a LAN 221, the configuration is not limited to this for the purpose of this invention. For example, the storage device and the router may be integrated in the server, or the server may b e a general purpose personal computer.

A user who wishes to play a game by using collected sales promotion points first exchanges the points to electronic tickets for gaming participation. More precisely, after the pre-determined information exchange with the sales promotion point exchange transaction center 211 in FIG. 2 by using the sales promotion point client terminal 202 or by using the PC 210, the user receives electronic tickets for gaming from the gaming service company who is an enterprise member of the sales promotion point exchange transaction service of this invention (refer to FIG. 1 and procedure (7) in FIG. 9). The user participates in a game, a questionnaire or a quiz that the gaming enterprise provides (procedure (a) in FIG. 9), plays actually (procedure (b) in FIG. 9) and receives electronic checks as a reward according to the points the user acquired in the game, or according to the contents of answers to the questionnaire or the quiz (procedure (c) in FIG. 9).

The user can save the electronic checks that the user got, and when the collected point amount reaches an enough volume, the user can request the system to exchange the points to a commodity that the user has selected on a Web mall of the gaming service provider, for example (procedure (d) in FIG. 9).

The gaming service provider can be an independent enterprise as an enterprise member of the sales promotion point exchange transaction service of this invention as shown by 218 in FIG. 2, or the operator who operates the sales promotion point exchange transaction center 211 in FIG. 2 can be the gaming service provider 218 at the same time. In the latter case, the game server system 218 can be directly connected to the LAN 213 of the sales promotion point exchange server system 214, instead of being connected to it through the Internet 203 and the routers 222 and 212 as shown in FIG. 2. Also in this case, the sales promotion point exchange server system 214 and the game server system 218 are not necessarily composed as two physically independent systems. For example, only the sales promotion point exchange server system 214 can exists with one or several integrated modules working for functions of the game server system 218.

### INDUSTRIAL APPLICABILITY

An enterprise, such as a manufacturer or a shop who participates in the sales promotion point exchange transaction service realized by the sales promotion point exchange transaction method and system of this invention, can flexibly and at any time set the exchange rate of the sales promotion points that the enterprise issues and a user consumes to purchase commodities or services of that enterprise or other enterprises. Through this capability, any participating enterprise can change the point value according to the commodity or the service, for example, so as to guide users to repeat purchasing or using commodities or services of the enterprise. Also through this capability, user's desires for utilizing the points of one enterprise to purchase commodities or services of other enterprises can be satisfied.

Also through this invention, an enterprise can utilize information such as the exchanged commodity or service, the exchange date, the user's profile, etc. that are collected at the. point consumption by the user, in order to establish its sales promotion strategy and its customer relation management strategy.

Also, it is possible for a user who is a member of the sales promotion point exchange transaction service of this invention to effectively utilize small amount of points, since points issued by different member enterprises can be summed up and utilized.

Furthermore, it is possible for a user who is a member of the sales promotion point exchange transaction service of this invention to purchase a commodity or a service at a better price, or to use the points more effectively, since the user can compare commodities or services offered by different enterprises, and can request estimation of the point present value.

1. An electronic circulation method in order to circulate electronic units for sales promotion, or simply sales promotion points hereafter, comprising (a) a sales promotion point issuance and consumption means that issues and consumes sales promotion points per each shop, manufacturer or group of them and consumes sales promotion points within said each shop, manufacturer or group of them based on pre-determined point issuance conditions and pre-determined point consumption conditions in response to the requesting operation by a user on a terminal, and that manages said pre-determined issuance conditions, said pre-determined consumption conditions, the point issuance history and the point consumption history, and (b) a sales promotion point exchange transaction means that makes said sales promotion points circulate not only within said each shop, manufacturer or group of them but also widely outside said each shop, manufacturer or group of them, wherein said sales promotion point exchange transaction means (p) manages a standard value of a sales promotion point that is arbitrarily determined by said each shop, manufacturer or group of them and that is consumed within said each shop, manufacturer or group of them, (q) manages an exchange rate between sales promotion points that are issued by and consumed within each shop, manufacturer or group of them and sales promotion points that are consumed outside said each shop, manufacturer or group of them wherein said exchange rate is arbitrarily determined by said each shop, manufacturer or group of them, (r) and executes sales promotion exchange transaction by calculating the necessary point amount required for exchange to a commodity or a service that a user wants based on said standard value of a sales promotion point and on said exchange rate, in response to the user's request.

2. An electronic circulation method claimed in claim 1, wherein said exchange rate between sales promotion points that are issued by and consumed within an each shop, manufacturer or group of them and sales promotion points that are consumed outside said each shop, manufacturer or group of them can be determined arbitrarily according to the shop or the manufacturer or the group of them that provides the commodity or the service, or according to the product or the service that are provided by the shop or the manufacturer or the group of them.

3. An electronic circulation method claimed in claim 2, wherein said exchange rate can be further flexibly determined according to time, a period or a season, and according to the attributes of the user who is a member of the sales promotion point exchange transaction service.

4. An electronic circulation method claimed in claim 1, wherein said exchange rate can be changed at any time from an information input and output terminal of said sales promotion point issuance and consumption means, and the changed exchange rate is reflected on the exchange transaction of said sales promotion points on a real time base.

5. An electronic circulation method claimed in claim 1, wherein data of said sales promotion point exchange transaction are fed back to the shop, the manufacturer or the group of them that issued said sales promotion points.

6. An electronic circulation method claimed in claim 1, wherein said requesting operation by a user on a terminal is an access operation to a home page on the Internet ordering a commodity or a prize.

7. An electronic circulation method claimed in claim 6, wherein said sales promotion points include points that are given when an advertising home page or a banner is accessed by the user.

8. An electronic circulation system in order to circulate electronic units for sales promotion, or simply sales promotion points hereafter, comprising (a) a sales promotion point issuance and consumption means that issues and consumes sales promotion points per each shop, manufacturer or group of them and consumes sales promotion points within said each shop, manufacturer or group of them based on pre-determined point issuance conditions and pre-determined point consumption conditions in response to the requesting operation by a user on a terminal, and that manages said pre-determined issuance conditions, said pre-determined consumption conditions, the point issuance history and the point consumption history, and (b) a sales promotion point exchange transaction means that makes said sales promotion points circulate not only within said each shop, manufacturer or group of them but also widely outside said each shop, manufacturer or group of them, wherein said sales promotion point exchange transaction means (p) manages a standard value of a sales promotion point that is arbitrarily determined by said each shop, manufacturer or group of them and that is consumed within said each shop, manufacturer or group of them, (q) manages an exchange rate between sales promotion points that are issued by and consumed within each shop, manufacturer or group of them and sales promotion points that are consumed outside said each shop, manufacturer or group of them wherein said exchange rate is arbitrarily determined by said each shop, manufacturer or group of them, (r) and executes sales promotion exchange transaction by calculating the necessary point amount required for exchange to a commodity or a service that a user wants based on said standard value of a sales promotion point and on said exchange rate, in response to the user's request.

9. An electronic circulation system claimed in claim 8, wherein said exchange rate between sales promotion points that are issued by and consumed within an each shop, manufacturer or group of them and sales promotion points that are consumed outside said each shop, manufacturer or group of them can be determined arbitrarily according to the shop or the manufacturer or the group of them that provides the commodity or the service, or according to the product or the service that are provided by the shop or the manufacturer or the group of them.

10. An electronic circulation system claimed in claim 9, wherein said exchange rate can be further flexibly determined according to time, a period or a season, and according to the attributes of the user who is a member of the sales promotion point exchange transaction service.

11. An electronic circulation system claimed in claim 8, wherein said exchange rate can be changed at any time from an information input and output terminal of said sales promotion point issuance and consumption means, and the changed exchange rate is reflected on the exchange transaction of said sales promotion points on a real time base.

12. An electronic circulation system claimed in claim 8, containing a procedure that displays on a user terminal the estimated user's present point value based on the consumption conditions including said exchange rate, and that enables for a user referring to said user's present point value displayed on the user terminal to input manually, or to specify automatic calculation of, the point value required for exchanging to a commodity or a service.

13. An electronic circulation system claimed in claim 8, wherein data of said sales promotion point exchange transaction are fed back to the shop, manufacturer or the group of them that issued said sales promotion points.

14. An electronic circulation system claimed in claim 8, wherein said requesting operation by a user on a terminal is an access operation to a home page on the Internet ordering a commodity or a prize.

15. An electronic circulation system claimed in claim 14, wherein said sales promotion points include points that are given when an advertising home page or a banner is accessed by the user.

16. A memory media used in the electronic circulation method in order to circulate electronic units for sales promotion or used in the electronic circulation system in order to circulate electronic units for sales promotion in which an executable program so that said sales promotion point exchange transaction means manages a standard value of a sales promotion point that is arbitrarily determined by said each shop, manufacturer or group of them and that is consumed within said each shop, manufacturer or group of them, manages an exchange rate between sales promotion points that are issued by and consumed within an each shop, manufacturer or group of them and sales promotion points that are consumed outside said each shop, manufacturer or group of them wherein said exchange rate is arbitrarily determined by said each shop, manufacturer or group of them, and executes sales promotion exchange transaction by calculating the necessary point amount required for exchange to a commodity or a service that a user wants based on said standard value of a sales promotion point and on said exchange rate, in response to the user's request.

17. A memory media used in the electronic circulation method in order to circulate electronic units for sales promotion or used in the electronic circulation system in order to circulate electronic units for sales promotion in which an executable program in order to enable said exchange rate to be changed at any time from an information input and output terminal of said sales promotion point issuance and consumption means, and in order to enable said changed exchange rate to be reflected on the exchange transaction of said sales promotion points on a real time base.

18. A memory media claimed in claim 17 in which an executable program that enables to display on a user terminal the estimated user's present point value based on the consumption conditions including said exchange rate, and that enables for a user referring to said user's present point value displayed on the user terminal to input manually, or to specify automatic calculation of, the point value required for exchanging to a commodity or a service, is stored.

19. An electronic circulation method claimed in claim 1, wherein said sales promotion points can be used by a user as a participation ticket for a gaming home page or for a quiz home page provided on the Internet, and the prize for winning the game or for answering the quiz is paid back to the user in the form of said sales promotion points.

20. An electronic circulation system claimed in claim 8, wherein said sales promotion points can be used by a user as a participation ticket for a gaming home page or for a quiz home page provided on the Internet, and the prize for winning the game or for answering the quiz is paid back to the user in the form of said sales promotion points.
